(19) United States
(12) Patent Application Publication
(10) Pub. No.: US 2020/0005791 A1
(43) Pub. Date: Jan. 2, 2020

(54) AUDIO CONTENT VISUALIZED BY PICO PROJECTION OF TEXT FOR INTERACTION

(71) Applicant: International Business Machines Corporation, Armonk, NY (US)

(72) Inventors: Sarbajit K. Rakshit, Kolkata (IN); Martin G. Keen, Cary, NC (US); James E. Bostick, Cedar Park, TX (US); John M. Ganci, JR., Cary, NC (US)

(21) Appl. No.: 16/024,501

(22) Filed: Jun. 29, 2018

(51) Int. Cl. G10L 15/26; G06F 3/01; G06F 17/24; H04M 1/02

(52) U.S. Cl. CPC G10L 15/265; H04M 1/0272; G06F 17/24; G06F 3/017

(57) ABSTRACT

A method includes processing, by a computing device, digital data to produce an analog domain audio signal and performing an audio to text conversion function on the analog domain audio signal to produce text data. During the processing of the digital data, when enabled, the method further includes capturing, by a camera system, a physical gesture by a user of the computing device where the physical gesture is regarding specific processing of the text data. When the specific processing includes displaying a portion of the text data, the method further includes identifying, by a processing module, the portion of the text data in accordance with the physical gesture regarding the specific processing of displaying the portion of the text data, and projecting, by a pico-projector, the portion of the text data onto a display area associated with the user.

### BACKGROUND

This invention relates generally to audio content processing for pico-projection of text and more particularly to context aware audio content processing by a personal communication system for pico-projection of text for interaction.

### SUMMARY

According to an embodiment of the invention, a computing device processes digital data to produce an analog domain audio signal. The computing device performs an audio to text conversion function on the analog domain audio signal to produce text data. During the processing of the digital data, when enabled, a camera system captures a physical gesture by a user of the computing device. The physical gesture is regarding specific processing of the text data. The specific processing includes one or more of: store the text data, store a portion of the text data, display the text data, and display a portion of the text data. When the specific processing includes displaying a portion of the text data, a processing module identifies the portion of the text data in accordance with the physical gesture regarding the specific processing of displaying the portion of the text data, and a pico-projector projects the portion of the text data onto a display area associated with the user.

### BRIEF DESCRIPTION OF THE SEVERAL VIEWS OF THE DRAWING(S)

FIGS. 1A-1B are schematic block diagrams of an embodiment of a personal communication system in accordance with the present invention;

FIG. 2 is a schematic block diagram of an embodiment of the personal communication system in accordance with the present invention;

FIGS. 3A-3B are schematic block diagrams of an embodiment of the personal communication system in accordance with the present invention;

FIG. 4 is a schematic block diagram of an embodiment of the personal communication system in accordance with the present invention; and

FIG. 5 is a logic diagram of an example of a method of context aware audio content processing for pico-projection of text for interaction in accordance with the present invention.

### DETAILED DESCRIPTION OF THE INVENTION

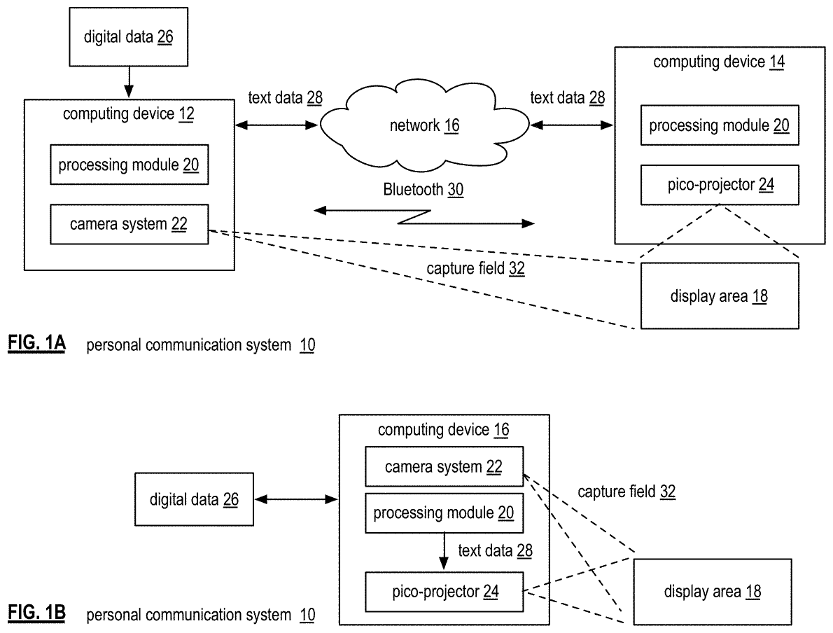

FIG. 1A is a schematic block diagram of an embodiment of a personal communication system 10 that includes computing device 12, computing device 14, network 16, and display area 18. Computing device 12 is paired with computing device 14 via network 16 and/or Bluetooth 30 (e.g., Bluetooth Low Energy (LE)) such that computing device 12 is operable to communicate with and transmit data to and from computing device 14. Network 16 may include one or more wireless and/or wire lined communication systems; one or more non-public intranet systems and/or public internet systems; and/or one or more local area networks (LAN) and/or wide area networks (WAN).

Computing device 12 includes processing module 20 and camera system 22. Computing device 12 may be any portable computing device operable to receive digital data 26 such as a smartphone, a cell phone, a digital assistant, a digital music player, a digital video player, a laptop computer, a handheld computer, a tablet, a smartwatch, etc. Camera system 22 may be a built-in camera (e.g., a camera on a smartphone) or separate device attachable to computing device 12. Computing device 14 includes processing module 20 and pico-projector 24 and may be any portable computing device such as a such as a smartphone, a cell phone, a digital assistant, a digital music player, a digital video player, a laptop computer, a handheld computer, a tablet, a smartwatch, a smart ring, etc. Pico-projector 24 is small image projector that may be a built-in pico-projector or a separate, portable device attachable to computing device 14.

Processing module 20 may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Processing module 20 may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if processing module 20 includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module 20 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and processing module 20 executes, hard coded and/or operational instructions corresponding to at least some of the steps and/or functions illustrated in one or more of the Figures. Such a memory device or memory element can be included in an article of manufacture.

In an example of operation, computing device 12 processes digital data 26 (e.g., audio of a phone call, an audio file, an audio portion of a video file, etc.) to produce an analog domain audio signal. Computing device 12 performs an audio to text conversion function on the analog domain audio signal to produce text data 28. Text data 28 is tagged with textual content stored in metadata associated with the digital data 26. For example, text data 28 is tagged for phone numbers, addresses, names, etc.

During the processing of the digital data 26, when enabled, camera system 22 captures a physical gesture by a user of computing device 12. Camera system 22 may be enabled manually (e.g., via a user input), by a default setting (e.g., every time a phone call is received, when computing device 14 is activated when computing device 12 is in use, etc.), and/or by an enabling gesture that activates the camera system. For example, the enabling gesture could be waving a hand in front of camera system 22 and/or performing a specific physical gesture in display area 18 that is captured within the capture field 32.

When enabled, camera system 22 is operable to capture physical gestures by a user of computing device 12 via capture field 32 within display area 18. Display area 18 is an area near pico-projector 24 of computing device 14 and visible to the user of computing device 12. For example, computing device 14 is a smartwatch worn by the user of computing device 12 and the display area is the user's palm, forearm, or back of hand. The enabling gesture may set the display area 18. For example, if the user of computing device 12 is wearing computing device 14 (e.g., a smartwatch) on his left hand and the user holds his left palm open within capture field 32 of the camera system 22, the user's palm is set as the projection point/display area 18 for pico-projector 24.

A physical gesture is regarding specific processing of text data 28. The physical gesture may include holding a palm open (when the palm is the display area 18), a swiping motion with one or more fingers in the display area 18, a tapping/pressing gesture in the display area 18, a scroll gesture in the display area 18, a dragging gesture in the display area 18, a repeated gesture (e.g., several swipes or taps in the display area 18 and/or opening and closing palm when the palm is the display area 18), a press and hold gesture, etc. The specific processing of text data 28 includes one or more of: store the text data, store a portion of the text data, display the text data, and display a portion of the text data. For example, during a phone call, the user of computing device 12 (e.g., smartphone receiving the phone call) may wish to view or tag specific portions of the spoken content (e.g., phone numbers, addresses, names, etc.) on a real-time basis (e.g., during a phone call, web conference, etc.). As another example, the user of computing device 12 may wish to view or tag specific portions of audio content stored on computing device 12.

When the specific processing includes display a portion of text data 28, processing module 20 (e.g., on computing device 12) identifies the portion of the text data 28 in accordance with the physical gesture regarding the specific processing of displaying the portion of the text data 28. Pico-projector 24 projects the portion of text data 28 onto display area 18. For example, computing device 12 is a smartphone held in the user's right hand, and computing device 14 is a smartwatch worn on the user's on his left hand creating a display area 18 on the user's left palm. Computing device 12 receives digital data 26 (e.g., audio from a phone call) and camera system 22 captures a gesture (e.g., a single tap gesture) by the user on display area 18. As an example, a tap gesture may signify the desire to display a most recent sentence of text data 28. The processing module 20 identifies the most recent sentence of text data 28 to transmit to computing device 14 for display on the display area 18. As another example, two tap gestures by the user on display area 18 may initiate the display of the last two most recent sentences of text data 28 onto the display area 18. As another example, a swiping motion by the user on display area 18 may initiate the display of all tagged text data 28 (e.g., numbers, addresses, names, etc.) onto the display area 18. The projection content automatically aligns based on a relative position between the display area 18 and the user's eye position such that the displayed text data 28 can be read clearly.

When the specific processing includes displaying all text data 28 as it is received in real time (e.g., during the phone call) or all text data 28 from a stored audio file, pico-projector 24 projects the text data 28 onto display area 18. For example, the user performs a gesture (e.g., opens palm for 3 seconds while receiving digital data or opens palm for 3 seconds when a stored audio file is selected on computing device 12) to initiate displaying text data 28 on display area 18 via pico-projector 24.

When the specific processing includes displaying all of the text data or displaying the portion of the text data, camera system 22 is operable to detect one or more other physical gestures by the user, where the other physical gestures are regarding specific further processing of the displayed text data. The specific further processing of the displayed text data includes one or more of: select, select all, copy, paste, cut, look-up, share, store the text data, store a portion of the text data, place call, fast-forward, pause, resume, play back, delete, trigger a text message, rewind, and scan. For example, as text data 28 is displayed on display area 18 in real time, the user performs a physical gesture (e.g., a double-tap gesture on the displayed text data 28) to pause further text data from being displayed. The user can perform another physical gesture (e.g., another double-tap gesture) to resume the display of the text data 28. The user can perform yet another physical gesture (e.g., a triple tap gesture) to fast-forward the display of the text data 28 to a current location.

As another example, when all tagged text data 28 (e.g., numbers, addresses, names, etc.) is displayed onto the display area 18, the user performs a physical gesture to select particular tagged text data (e.g., an address). The user can perform another physical gesture to look-up (e.g., initiate a web browser search) the tagged text data, share (e.g., send in an email, post to social media, send in a text message, etc.) the tagged text data, copy and paste the tagged text data (e.g., to a notepad function on computing device 12), store the tagged text data (e.g., to an address book, contact list, calendar, etc. on computing device 12), etc.

Alternatively, when a portion of text data is selected, camera system 22 is operable to capture another physical gesture by the user of the computing device, where the physical gesture is regarding selecting the displayed portion of the text data for follow-up options. For example, the user presses down on a portion of displayed text data 28 to select the displayed portion of the text data for follow-up options. Pico-projector 24 projects follow-up options regarding further processing of the portion of the text data onto display area 18. The follow-up options include one or more of: copy, paste, cut, look-up, share, store, place call, fast-forward, pause, resume, play back, delete, trigger a text message, rewind, and scan. Camera system 22 captures another physical gesture from the user to signify selection of an option of the follow-options. For example, the user may use a one-fingered tap gesture on the displayed follow-up option to indicate selection of the displayed follow-up option. As an example, when the selected follow-up option is place call, computing device 12 receives a request to place a phone call to a phone number as indicated in the selected portion of text data. Computing device 12 detects when a current phone call producing digital data 26 ends and places the phone call to a second computing device associated with the phone number.

As another example, when the selected follow-up option is trigger a text message, computing device 12 receives a request to write a text message to the phone number as indicated in the portion of the text data 28. Computing device 12 displays a screen for the user to enter a text message to the second computing device associated with the phone number. When indicated by the user, computing device 12 sends the text message to the second computing device associated with the phone number.

When the specific processing includes store a portion of the text data 28, processing module 20 (e.g., on computing device 12) identifies the portion of the text data 28 in accordance with the physical gesture regarding the specific processing of storing the portion of the text data 28. Computing device 12 stores the portion of the text data 28. For example, computing device 12 is a smartphone held in the user's right hand and computing device 14 is a smartwatch held in the user's left hand creating a display area 18 on the user's left palm. The portion of the text data may already be displayed (as discussed above) and camera system 22 captures another physical gesture indicating that the user wishes to store the portion of the displayed text data 28 (e.g., by a two fingered tap on the displayed portion of the text data 28). For example, a swiping motion by the user on display area initiated the display of all tagged text data (e.g., numbers, addresses, names, etc.) onto display area 18 and a swipe/drag gesture over the selected tagged text data in the direction of computing device 12 stores that text data to computing device 12 in a desired context (e.g., a phone number is added to contacts lists, an address is added to contact list and/or displayed in maps, etc.).

As another example, when text data 28 is not already displayed, a gesture on display area 18 may initiate storage of a specific portion of text data 28 heard by the user. For example, the user performs a two-fingered tap gesture on display area 18, and processing module 20 identifies the most recent sentence of text data 28 to store on computing device 12. As another example, two, two-fingered tap gestures by the user on display area 18 may initiate the storing of the last two most recent sentences of text data 28 onto computing device 12.

When the specific processing includes store text data, computing device 12 stores all of the text data 28. For example, the user performs a physical gesture (e.g., opens and closes his palm) when digital data 26 is received (e.g., at the beginning of a phone call) to initiate storing the text data 28 of the phone call to computing device 12.

FIG. 1B is a schematic block diagram of an embodiment of the personal communication system 10 that includes computing device 16 and display area 18. Computing device 16 includes camera system 22, processing module 20, and pico-projector 24. Computing device 16 may be any portable computing device operable to receive digital data 26 such as a smartphone, a cell phone, a digital assistant, a digital music player, a digital video player, a laptop computer, a handheld computer, a tablet, a smartwatch, etc. Camera system 22 may be a built-in camera (e.g., a camera on a smartphone) or separate device attachable to computing device 16. Pico-projector 24 is small image projector that may be a built-in pico-projector or a separate, portable device attachable to computing device 16.

Computing device 16 operates similarly to the combination of computing devices 12 and 14 of FIG. 1A. For example, computing device 16 processes digital data 26 (e.g., audio of a phone call, an audio file, an audio portion of a video file, etc.) to produce an analog domain audio signal. Computing device 16 performs an audio to text conversion function on the analog domain audio signal to produce text data 28. Text data 28 is tagged with textual content stored in metadata associated with the digital data 26. For example, text data 28 is tagged for phone numbers, addresses, names, etc.

During the processing of the digital data 26, when enabled, camera system 22 captures a physical gesture by a user of computing device 16 within capture field 32. Display area 18 is an area near pico-projector 24 of computing device 16 and visible to the user of computing device 16. For example, computing device 16 is a smartphone having a pico-projector 24 and camera system 22 positioned at the bottom of the smartphone so that the display area 18 is the palm or forearm of the user's hand that is holding computing device 16.

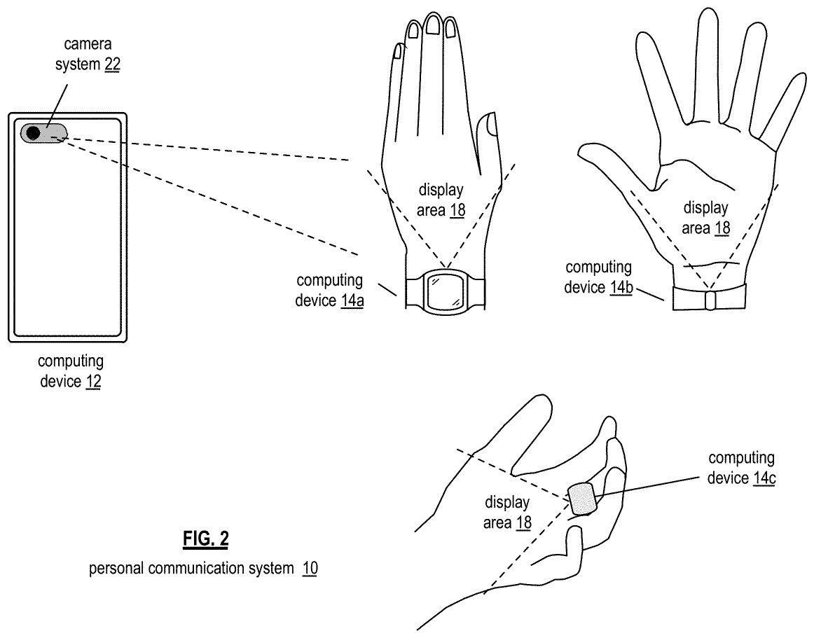

FIG. 2 is a schematic block diagram of an embodiment of the personal communication system 10 that includes computing device 12 and different examples of computing device 14 of FIG. 1A (i.e., computing devices 14a-14c) with corresponding display areas 18. In this example, computing device 12 is a smartphone or mobile phone having a built-in camera system 22 located on the back of computing device 12. Computing device 14a is a smartwatch having a pico-projector positioned near the face of the watch such that the display area 18 is the top of the user's hand. Alternatively, the display area 18 could project down on the user's forearm depending on the placement of the pico-projector.

Computing device 14b is a smartwatch having a pico-projector located on the strap of the watch such that the display area 18 is on the user's palm. Alternatively, the display area 18 could project down on the user's forearm depending on the placement of the pico-projector. Computing device 14c is a smart ring having a pico-projector located on the back of the ring such that the display area 18 is on the user's palm.

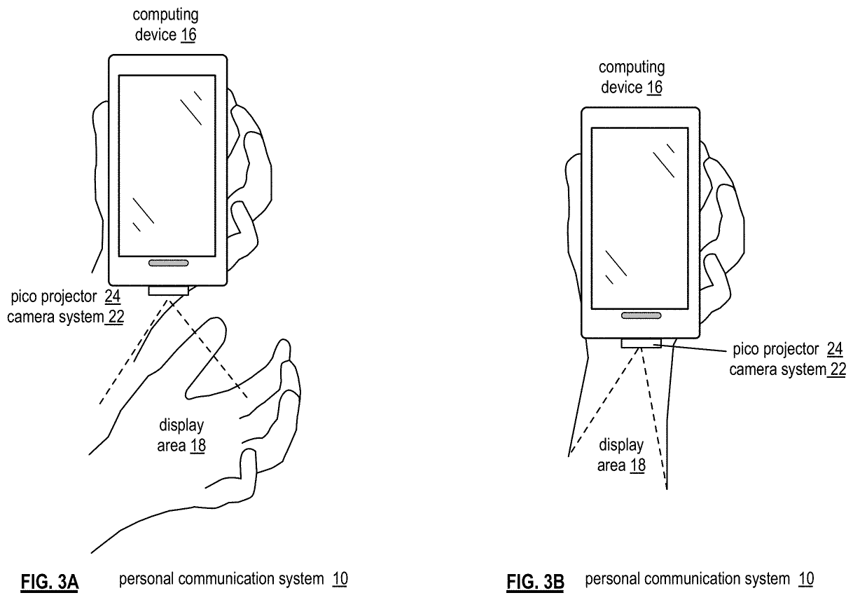

FIGS. 3A-3B are schematic block diagrams of an embodiment of the personal communication system 10. FIG. 3A includes computing device 16 and display area 18.

Computing device 16 (e.g., shown here as a smartphone) includes a pico-projector 24 and a camera system 22 positioned at the base of computing device 16 such that, if the user is holding computing device 16 (e.g., computing device 16 is a smartphone and the user is on a phone call) in one hand, the display area 18 is the user's opposite palm, hand, or forearm.

FIG. 3B includes computing device 16 and display area 18. Computing device 16 (e.g., shown here as a smartphone) includes a pico-projector 24 and a camera system 22 positioned at the base of computing device 16 such that, if the user is holding computing device 16 (e.g., computing device 16 is a smartphone and the user is on a phone call) in one hand, the display area 18 can be displayed on the user's forearm or palm of the hand holding computing device 16.

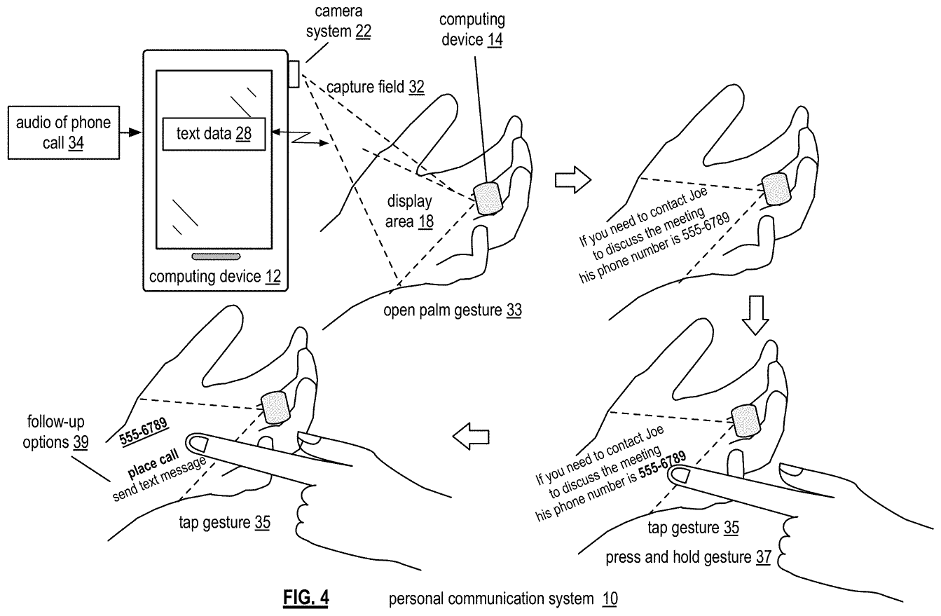

FIG. 4 is a schematic block diagram of an embodiment of the personal communication system 10 that includes computing device 12 and computing device 14.

Computing device 12 and computing device 14 are paired via a wireless network or Bluetooth. In this example, computing device 12 is a user's smartphone or mobile phone having camera system 22, and computing device 14 is a smart ring worn on the user's ring finger. In an example of operation, computing device 12 processes the audio of a phone call 34 to produce an analog domain audio signal. Computing device 12 performs an audio to text conversion function on the analog domain audio signal to produce text data 28. The text data 28 is tagged with textual content stored in metadata associated with the audio of the phone call 34. For example, text data 28 is tagged for phone numbers, addresses, names, etc.

During the processing of the audio of the phone call 34, when enabled, camera system 22 captures a physical gesture by the user on display area 18 within capture field 32. For example, the user holds the palm of the hand wearing computing device 14 open within capture field 32 of the camera system 22 to enable the camera system 22 and to set the user's palm as the projection point/display area 18 for pico-projector of computing device 14.

A physical gesture is regarding specific processing of text data. The specific processing of text data includes one or more of: store the text data, store a portion of the text data, display the text data, and display a portion of the text data. For example, the user of computing device 12 is on a phone call and wishes to view the spoken content on a real-time basis. The user, wearing computing device 14 (e.g., a smart ring) on his left hand, performs an open palm gesture 33 (e.g., opens his left palm for 3 seconds) to initiate displaying the text data on the display area 18 via the pico-projector. The projection content automatically aligns based on a relative position between the display area 18 and the user's eye position such that the displayed text data can be read clearly.

As an example, the real time text data 28 of “If you need to contact Joe to discuss the meeting, his phone number is 555-6789” is displayed on display area 18 (e.g., the user's palm). The camera system 22 is operable to detect one or more other physical gestures by the user, where the other physical gestures are regarding specific further processing of the displayed text data. The specific further processing of the displayed text data includes one or more of: select, select all, copy, paste, cut, look-up, share, store the text data, store a portion of the text data, place call, fast-forward, pause, resume, play back, delete, trigger a text message, rewind, and scan. For example, as the user views the incoming text data, the user selects the phone number “555-6789” using a single-finger tap gesture 35. The user may then use another gesture to further process the selected text (e.g., drag towards computing device 12 to save the phone number to contacts) or use another gesture to display follow-up options for the displayed and selected text data.

Here, the user performs a press and hold gesture 37 on the selected text data to display follow-up options 39. The pico-projector projects follow-up options 39 regarding processing of the portion of the text data onto the display area 18. The follow-up options include one or more of: copy, paste, cut, look-up, share, store, place call, fast-forward, pause, resume, play back, delete, trigger a text message, rewind, and scan. The user may use a one-fingered tap gesture to indicate selection of a displayed follow-up option. Here, because the selected portion of text data is a phone number, the pico-projector projects the follow-up options of “place call” and “send a text message.” The user selects the “place call” follow-up option via a single-finger tap gesture 35 on the option. Computing device 12 receives a request to place a phone call to 555-6789 as indicated in the selected portion of text data. Computing device 12 detects when the current phone call producing the audio of the phone call 34 ends and places the phone call to 555-6789. After, the follow-up option is selected, text data 28 of the current phone call resumes display until the phone call is completed or the camera system detects a gesture for other text data 28 processing.

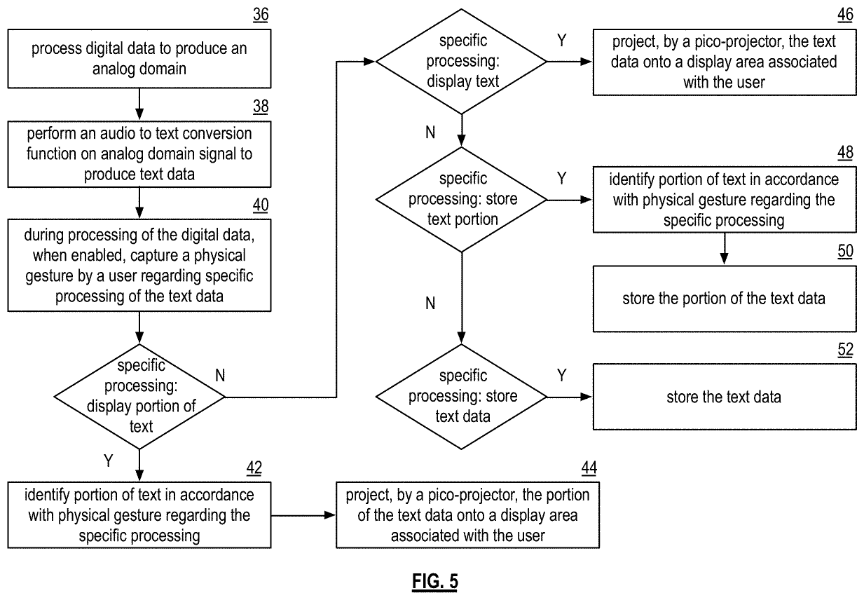

FIG. 5 is a logic diagram of an example of a method of context aware audio content processing for pico-projection of text for interaction. The method begins with step 36 where a computing device processes digital data (e.g., audio of a phone call, an audio file, an audio portion of a video file, etc.) to produce an analog domain audio signal. The method continues with step 38 where the computing device performs an audio to text conversion function on the analog domain audio signal to produce text data. The text data is tagged with textual content stored in metadata associated with the digital data. For example, text data is tagged for phone numbers, addresses, names, etc.

The method continues with step 40 where, during the processing of the digital data, when enabled, a camera system captures a physical gesture by a user of the computing device. The camera system may be enabled manually (e.g., via a user input), by a default setting (e.g., every time a phone call is received, when the computing device is in use, etc.), and/or by an enabling gesture that activates the camera system. For example, the enabling gesture could be waving a hand in front of camera system, and/or performing a specific physical gesture in a display area associated with the user.

When enabled, the camera system is operable to capture physical gestures by the user of the computing device within the display area. The display area is an area near a pico-projector, visible to the user of the computing device, and within the capture field of the camera system. For example, the computing device is a smartphone that includes a camera system and pico-projector positioned near the bottom of the computing device such that when the user is answering a phone call, the display area is the user's palm, forearm, or back of the hand. The enabling gesture may set the display area. For example, if the user holds his palm open within the capture field of the camera system, the user's palm is set as the projection point for the pico-projector.

A physical gesture is regarding specific processing of text data. The physical gesture may include holding a palm open (when the palm is the display area), a swiping motion with one or more fingers in the display area, a tapping/pressing gesture in the display area, a scroll gesture in the display area, a dragging gesture in the display area, a repeated gesture (e.g., several swipes or taps in the display area, and/or opening and closing palm when the palm is the display area), a press and hold gesture, etc. The specific processing of text data includes one or more of: store the text data, store a portion of the text data, display the text data, and display a portion of the text data. For example, during a phone call, the user of the computing device (e.g., smartphone receiving the phone call) may wish to view or tag specific portions of the spoken content (i.e., phone number, address, names, etc.) on a real-time basis. As another example, the user of the computing device may wish to view or tag specific portions of audio content stored on computing device.

When the specific processing includes displaying a portion of the text data, the method continues with step 42 where a processing module on (e.g., of the computing device) identifies the portion of the text data in accordance with the physical gesture regarding the specific processing of displaying the portion of the text data. The method continues with step 44 where the pico-projector projects the portion of the text data onto the display area associated with the user. For example, the camera system captures gesture by the user (e.g., a tap gesture) on display area where a tap gesture indicates the desire to display the most recent sentence of text data. The processing module identifies the most recent sentence of text data to project on the display area. As another example, two taps by the user on display area may initiate the display of the last two most recent sentences of text data onto the display area. As another example, a swiping motion by the user on display area initiates the display of all tagged text data (e.g., numbers, addresses, names, etc.) onto the display area. The projection content automatically aligns based on a relative position between the display area and the user's eye position such that the displayed text data can be read clearly.

When the specific processing includes display text data as it is received in real time (e.g., during the phone call) or all text data from a stored audio file, the method continues with step 46 where the pico-projector projects the text data onto the display area associated with the user. For example, the user performs a gesture (e.g., opens palm for 3 seconds while receiving digital data or opens palm for 3 seconds when a stored audio file is selected on computing device 12) to initiate displaying the text data on the display area via the pico-projector.

When the specific processing includes display the text data or display the portion of the text data, the camera system is operable to capture a second physical gesture by the user, where the second physical gesture is regarding specific further processing of the displayed text data. The specific further processing of the displayed text data includes one or more of: select, select all, copy, paste, cut, look-up, share, store the text data, store a portion of the text data, place call, fast-forward, pause, resume, play back, delete, trigger a text message, rewind, and scan. For example, as text data is displayed in the display area, the user performs a physical gesture (e.g., a double-tap gesture on the displayed text data 28) to pause further text data from being displayed. The user can perform another physical gesture (e.g., another double-tap gesture) to resume the display of the text data 28. The user can perform yet another physical gesture (e.g., a triple tap gesture) to fast-forward the display of the text data 28 to a current location.

Alternatively, when a portion of text data is selected, the camera system is operable to capture a physical gesture by the user of the computing device, where the physical gesture is regarding selecting the displayed portion of the text data for follow-up options. For example, the user presses down on a portion of displayed text data to select the displayed portion of the text data for follow-up options. When a portion of text data is selected from the displayed text data, the pico-projector projects follow-up options regarding further processing of the portion of the text data onto the display area. The follow-up options include one or more of: copy, paste, cut, look-up, share, store, place call, fast-forward, pause, resume, play back, delete, trigger a text message, rewind, and scan. The camera system captures another physical gesture from the user to signify selection of an option of the follow-options. For example, the user may use a one-fingered tap gesture on the follow-up option to indicate selection of the displayed follow-up option. As an example, when the selected follow-up option is place call, the computing device receives a request to place a phone call to a phone number as indicated in the selected portion of text data. The computing device detects when a current phone call producing the digital data ends and places the phone call to a second computing device associated with the phone number.

As another example, when the selected option is trigger a text message, the computing device receives a request to write a text message to the phone number as indicated in the portion of the text data. The computing device displays a screen for the user to enter a text message to the second computing device associated with the phone number. When indicated by the user, the computing device sends the text message to the second computing device associated with the phone number.

When the specific processing includes save a portion of the text data, the method continues with step 48 where the processing module (e.g., on the computing device) identifies the portion of the text data in accordance with the physical gesture regarding the specific processing of storing the portion of the text data. The method continues with step 50 where the computing device stores the portion of the text data. For example, the portion of the text data may already be displayed (via steps 42-44) and the camera system captures another gesture indicating that the user wishes to store the portion of the displayed text data (e.g., by a two fingered tap on the displayed portion of the text data). For example, a swiping motion by the user on the display area initiates the display of all tagged text data (e.g., numbers, addresses, names, etc.) onto the display area and a swipe/drag gesture over the selected tagged text data in the direction of the computing device stores that text data to the computing device in desired context (e.g., a phone number is added to contacts lists, an address is added to contact list and/or displayed in maps, etc.).

As another example, when text data is not already displayed, a gesture on the display area may initiate storage of a specific portion of text data heard by the user. For example, the user performs a two-fingered tap on the display area, and the processing module identifies the most recent sentence of text data to store on the computing device. As another example, two, two-fingered taps by the user on the display area may initiate the storing of the last two most recent sentences of text data onto the computing device.

When the specific processing includes store text data, the method continues with step 52 where the computing device stores all of the text data as it is processed. For example, the user opens and closes his palm (e.g., the display area) at the beginning of a phone call to initiate saving the text data of the phone call to the computing device.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
processing, by a computing device, digital data to produce an analog domain audio signal;
performing, by the computing device, an audio to text conversion function on the analog domain audio signal to produce text data; and
during the processing of the digital data:
when enabled, capturing, by a camera system, a physical gesture by a user of the computing device, wherein the physical gesture is regarding specific processing of the text data, wherein the specific processing includes one or more of: store the text data, store a portion of the text data, display the text data, and display a portion of the text data; and
when the specific processing includes displaying a portion of the text data:
identifying, by a processing module, the portion of the text data in accordance with the physical gesture regarding the specific processing of displaying the portion of the text data; and
projecting, by a pico-projector, the portion of the text data onto a display area associated with the user.

2. The method of claim 1, wherein the digital data includes one or more of:
audio of a phone call;
audio file; and
audio portion of a video file.

3. The method of claim 1 further comprises:
when the specific processing includes store the text data:
storing, by the computing device, the text data.

4. The method of claim 1 further comprises:
when the specific processing includes store a portion of the text data,
identifying, by the processing module, the portion of the text data in accordance with physical gesture regarding the specific processing of storing the portion of the text data; and
storing, by the computing device, the portion of the text data.

5. The method of claim 1 further comprises:
when the specific processing includes display the text data:
projecting, by the pico-projector, the text data onto the display area associated with the user.

6. The method of claim 5 further comprises:
when the specific processing includes display the text data or display the portion of the text data:
capturing, by the camera system, a second physical gesture by the user of the computing device, wherein the second physical gesture is regarding specific further processing of displayed text data, wherein the specific further processing of the displayed text data includes one or more of: select, select all, copy, paste, cut, look-up, share, store the text data, store a portion of the text data, place call, fast-forward, pause, resume, play back, delete, trigger a text message, rewind, and scan.

7. The method of claim 1 further comprises:
capturing, by the camera system, a second physical gesture by the user of the computing device, wherein the physical gesture is regarding selecting the displayed portion of the text data for follow-up options;
projecting, by the pico-projector, follow-up options regarding further processing of the portion of the text data onto the display area, wherein the follow-up options include one or more of: copy, paste, cut, look-up, share, store, place call, fast-forward, pause, resume, play back, delete, trigger a text message, rewind, and scan;
capturing, by the camera system, a third physical gesture to signify selection of an option of the follow-up options; and
when the selected option is place call:
receiving, by the computing device, a request to place a phone call to a phone number as indicated in the portion of the text data;
detecting, by the computing device, when a current phone call producing the digital data ends; and
placing, by the computing device, the phone call to a second computing device associated with the phone number.

8. The method of claim 7 further comprises:
when the selected option is trigger a text message:
receiving, by the computing device, a request to write a text message to the phone number as indicated in the portion of the text data;
displaying, by the computing device, a screen for the user to enter a text message to the second computing device associated with the phone number; and
when indicated by the user, sending, by the computing device, the text message to the second computing device associated with the phone number.

9. A personal communication system comprises:
a computing device;
a camera system;
a processing module; and
a pico-projector, wherein the computing device is operable to:
process digital data to produce an analog domain audio signal;
perform audio to text conversion function on the analog domain audio signal to produce text data; and
wherein, during the processing of the digital data:
the camera system, when enabled, captures a physical gesture by a user of the computing device, wherein the physical gesture is regarding specific processing of the text data, wherein the specific processing includes one or more of: store the text data, store a portion of the text data, display the text data, and display a portion of the text data;
when the specific processing includes displaying a portion of the text data:
the processing module identifies the portion of the text data in accordance with the physical gesture regarding the specific processing of displaying the portion of the text data; and
the pico-projector projects the portion of the text data onto a display area associated with the user.

10. The personal communication system of claim 9, wherein the computing device includes the camera system, the processing module, and the pico-projector.

11. The personal communication system of claim 9, wherein a second computing device includes a second camera system, a second processing module, and a second pico-projector.

12. The personal communication system of claim 9, wherein the digital data includes one or more of:
audio of a phone call;
audio file; and
audio portion of a video file.

13. The personal communication system of claim 9 further comprises:
when the specific processing includes store the text data:
the computing device stores the text data.

14. The personal communication system of claim 9 further comprises:
when the specific processing includes store a portion of the text data,
the processing module identifies the portion of the text data in accordance with physical gesture regarding the specific processing of storing the portion of the text data; and
the computing device stores the portion of the text data.

15. The personal communication system of claim 9 further comprises:
when the specific processing includes display the text data:
the pico-projector projects the text data onto the display area associated with the user.

16. The personal communication system of claim 15 further comprises:
when the specific processing includes display the text data or display the portion of the text data:
the camera system captures a second physical gesture by the user of the computing device, wherein the second physical gesture is regarding specific further processing of displayed text data, wherein the specific further processing of the displayed text data includes one or more of: select, select all, copy, paste, cut, look-up, share, store the text data, store a portion of the text data, place call, fast-forward, pause, resume, play back, delete, trigger a text message, rewind, and scan.

17. The personal communication system of claim 9 further comprises:
the camera system captures a second physical gesture by the user of the computing device, wherein the physical gesture is regarding selecting the displayed portion of the text data for follow-up options;
the pico-projector projects follow-up options regarding further processing of the portion of the text data onto the display area, wherein the follow-up options include one or more of: copy, paste, cut, look-up, share, store, place call, fast-forward, pause, resume, play back, delete, trigger a text message, rewind, and scan;
the camera system captures a third physical gesture to signify selection of an option of the follow-up options; and
when the selected option is place call:
the computing device receives a request to place a phone call to a phone number as indicated in the portion of the text data;
the computing device detects when a current phone call producing the digital data ends; and
the computing device places the phone call to a second computing device associated with the phone number.

18. The personal communication system of claim 17 further comprises:
when the selected option is trigger a text message:
the computing device receives a request to write a text message to the phone number as indicated in the portion of the text data;
the computing device displays a screen for the user to enter a text message to the second computing device associated with the phone number; and
when indicated by the user, the computing device sends the text message to the second computing device associated with the phone number.
